(19) United States
(12) Patent Application Publication
(10) Pub. No.: US 2010/0142186 A1
(43) Pub. Date: Jun. 10, 2010

(54) LIGHT SOURCE HOLDING DEVICE, ILLUMINATION DEVICE, AND DISPLAY DEVICE

(75) Inventor: Kentaroh Aoki, Katsushika-ku (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 11/996,779

(22) PCT Filed: Jul. 7, 2006
(86) PCT No.: PCT/JP2006/313569

§ 371 Date: Jan. 25, 2008

(30) Foreign Application Priority Data
Sep. 9, 2005 (JP) 2005-262795

(51) Int. Cl. G02F 1/13357; F21V 19/00; F21V 21/00

(52) U.S. Cl. 362/97.2; 362/382; 362/217.14; 362/97.1

(57) ABSTRACT

In a light source holding device holding a cold cathode tube (linear light source) by clamping it between first and second claws, the first and second claws are provided in such a manner that they are in contact with the cold cathode tube while being displaced in position in the longitudinal direction of the cold cathode tube. Consequently, degradation in display quality can be prevented.

### BACKGROUND OF THE INVENTION

1. Field of the Invention

The present invention relates to a light source holding device holding a linear light source such as a cold cathode tube, and an illumination device and a display device that use the light source holding device.

2. Description of the Related Art

Recently, a liquid crystal display device, for example, has been used widely for liquid crystal televisions, monitors, mobile telephones, and the like as a flat panel display having features such as thinness and light weight compared with conventional Braun tubes. Such a liquid crystal display device includes an illumination device (backlight) emitting light, and a liquid crystal panel that functions as a shutter with respect to light from a light source provided in the illumination device to display a desired image, for example, as described in JP 2005-158707 A.

The illumination device is classified roughly into a direct type and an edge-light type depending upon the arrangement of the light source with respect to the liquid crystal panel. In the liquid crystal display device having a liquid crystal panel of 20 inches or more, the direct type illumination device that is increased in brightness and easily enlarged compared with the edge-light type is used generally. More specifically, the direct type illumination device has a configuration in which a plurality of linear light sources are placed on a back (non-display surface) side of a liquid crystal panel, and the linear light sources can be placed immediately on a reverse side of the liquid crystal panel, which enables a number of linear light sources to be used. Thus, the direct type illumination device is likely to have a high brightness, and is suitable for an increased brightness and enlargement. Furthermore, the inside of the direct type illumination device has a hollow structure, so that it is light-weight even if it is enlarged, and hence it is suitable for the increase in brightness and enlargement.

Furthermore, in the direct type illumination device as described above, it has been proposed that a fluorescent tube is held as the linear light source using a light source holding device, for example, as described in JP 2001-210126 A. Specifically, in the conventional example, two claws forming a U-shape are provided in the light source holding device, and the fluorescent tube is held by being clamped between the U-shaped claws. Then, in the conventional example, even when the fluorescent tube, whose length is enlarged in accordance with the enlargement of a screen of the liquid crystal panel, is used, the fluorescent tube is positioned with good precision, whereby brightness non-uniformity is prevented from occurring on the display surface of the liquid crystal panel due to displacement in the position of the fluorescent tube.

However, in the conventional light source holding device as described above, since the fluorescent tube (linear light source) is clamped between the U-shaped claws, the brightness of light output from the fluorescent tube is reduced partially, with the result that the display quality on the display surface of the liquid crystal panel may be degraded.

More specifically, in a portion where the fluorescent tube with the conventional light source holding device mounted thereon is placed, the surface of the fluorescent tube is covered with the two claws opposed to each other, excluding the U-shaped opening, and light output toward an outer circumferential direction of the fluorescent tube is blocked simultaneously by the two claws. That is, in the mounting portion of the fluorescent tube, the amount of light output in a direction perpendicular to the longitudinal direction of the fluorescent tube is reduced greatly compared with that in a portion where the light source holding device is not mounted. Therefore, the brightness of light output from the fluorescent tube is reduced partially, which may form a light portion and a dark portion in the longitudinal direction of the fluorescent tube. As a result, in an illumination device using the conventional light source holding device, plane-shaped light with a uniform brightness cannot be allowed to be incident upon the liquid crystal panel, with the result that brightness non-uniformity occurs on the display surface of the liquid crystal panel and shadows of the claws appear remarkably, which may degrade the display quality on the display surface.

### SUMMARY OF THE INVENTION

In view of the above-described problems, preferred embodiments of the present invention provide a light source holding device capable of preventing the degradation in display quality, and an illumination device and a display device that use the light source holding device.

A light source holding device according to a preferred embodiment of the present invention holds a linear light source by clamping the linear light source between two claws, wherein the two claws are arranged so as to be in contact with the linear light source while being displaced in position in a longitudinal direction of the linear light source.

The two claws of the light source holding device configured as described above are arranged to be in contact with the linear light source while being displaced in position in the longitudinal direction of the linear light source. According to this configuration, unlike the above-described conventional examples, the surface of the linear light source that is blocked simultaneously by the two claws in a direction substantially perpendicular to the longitudinal direction of the linear light source can be reduced. Consequently, the brightness of light output from the linear light source can be minimized from being decreased partially, and degradation in display quality can be prevented.

Furthermore, the above-mentioned light source holding device may include a base portion which is placed below the linear light source and to which each lower end side of the two claws is connected, wherein the base portion may be provided with an engagement portion that is engaged with a reflection plate reflecting light from the linear light source.

In this case, the linear light source can be held stably while the light use efficiency of the linear light source is enhanced with the reflection plate.

Furthermore, in the above-mentioned light source holding device, it is preferred that, assuming that a size of the one claw in the longitudinal direction of the linear light source is L and a displacement size of the other claw with respect to the one claw in the longitudinal direction of the linear light source is Z, the size L and the displacement size Z satisfy the following inequality

(1): 0.1×L≦Z (1).

In this case, the partial decrease in brightness of light from the linear light source can be minimized, and the degradation in display quality can be prevented.

Furthermore, in the above-mentioned light source holding device, the displacement size Z may be a value equal to or lower than the size L.

In this case, the holding (grabbing) force of the two claws with respect to the linear light source is more precise, whereby the degradation in display quality can be prevented while the linear light source is held by the light source holding device in a stable state.

Furthermore, in the above-mentioned light source holding device, at least one of the one claw and the other claw may be divided into a plurality of claw portions in the longitudinal direction of the linear light source.

In this case, the surface of the linear light source that is blocked simultaneously by the two claws can be subdivided to be reduced in size in the direction substantially perpendicular to the longitudinal direction of the linear light source, whereby the partial decrease in brightness of light output from the linear light source can be easily minimized.

Furthermore, in the above-mentioned light source holding device, it is preferred that the one claw and the other claw respectively are divided into a plurality of claw portions in the longitudinal direction of the linear light source, and the claw portions of the one claw and the claw portions of the other claw are placed alternately so as not to be opposed to each other in the direction substantially perpendicular to the longitudinal direction of the linear light source.

In this case, in the direction substantially perpendicular to the longitudinal direction of the linear light source, the linear light source can be held by being clamped between the two claws, while the surface of the linear light source is prevented from being blocked simultaneously by the two claws, whereby the partial decrease in brightness of light output from the linear light source can be minimized.

Furthermore, in the above-mentioned light source holding device, a contact area between the one claw and the linear light source may be equal to a contact area between the other claw and the linear light source.

In this case, the linear light source can be clamped between the two claws in a balanced manner, so that the light source holding device can hold the linear light source in a more stable state.

Furthermore, the above-mentioned light source holding device may include a plurality of sets of the two claws respectively holding a plurality of linear light sources, and a connecting portion connecting two sets of the two claws adjacent to each other in the direction substantially perpendicular to the longitudinal direction of the linear light source.

In this case, the light source holding device can hold a plurality of linear light sources integrally, and an interval (pitch) size of two linear light sources adjacent to each other can be kept to be a desired size.

Furthermore, in the above-mentioned light source holding device, it is preferred that the connecting portion connects the two sets of the two claws diagonally to the longitudinal direction so that the two sets of the two claws are not placed on a straight line in the direction substantially perpendicular to the longitudinal direction of the linear light source.

In this case, the partial decrease in brightness of light output from each of a plurality of linear light sources can be minimized while the light source holding device holds the plurality of linear light sources integrally, whereby the degradation in display quality can be prevented.

Furthermore, in the above-mentioned light source holding device, it is preferred that the entire light source holding device is preferably formed integrally of a metal or resin material.

In this case, the light source holding device can hold the linear light source in a more stable state while minimizing the influence of heat generated from the linear light source.

Furthermore, in the above-mentioned light source holding device, the claws may have a white or milk white color.

In this case, since the claws have substantially the same color as the light-emission color of the linear light source, the light source holding device can hold the linear light source while preventing the degradation in display quality more easily.

Furthermore, an illumination device of various preferred embodiments of the present invention includes a linear light source, wherein the linear light source is held using any of the above-mentioned light source holding devices.

In the illumination device configured as described above, the light source holding device that minimizes the partial decrease in brightness of light output from the linear light source is used, so that the illumination device can irradiate plane-shaped light with a uniform brightness, thereby minimizing the occurrence of brightness non-uniformity to prevent the degradation in display quality.

Furthermore, in the above-mentioned illumination device, any discharge tube among a cold cathode tube, a hot cathode tube, and a xenon tube, or a plurality of light-emitting diodes arranged on a straight line may used as the linear light source.

In this case, an illumination device capable of emitting uniform plane-shaped light with a high brightness can be easily configured.

Furthermore, a display device of various preferred embodiments of the present invention preferably includes a linear light source and a display portion irradiated with light from the linear light source, wherein the linear light source is held using any of the above-mentioned light source holding devices.

In the display device configured as described above, the light source holding device that minimizes the partial decrease in brightness of light output from the linear light source is used. Therefore, plane-shaped light with a uniform brightness is incident upon the display portion, brightness non-uniformity and the shadows of the claws are prevented from occurring on the display surface of the display portion, which can prevent the degradation in display quality.

Furthermore, in the display device, it is preferred that a liquid crystal panel is used as the display portion.

In this case, brightness non-uniformity and the shadows of the claws are prevented from occurring on the display surface of the liquid crystal panel, which enables a liquid crystal display device excellent in display quality to be configured at a low cost.

According to preferred embodiments of the present invention, a light source holding device capable of preventing the degradation in display quality, and an illumination device and a display device that use the light source holding device can be provided.

Other features, elements, processes, steps, characteristics and advantages of the present invention will become more apparent from the following detailed description of preferred embodiments of the present invention with reference to the attached drawings.

### BRIEF DESCRIPTION OF DRAWINGS

FIG. 1 is a schematic cross-sectional view illustrating a display device according to a first preferred embodiment of the present invention.

FIG. 2 is a plan view illustrating configurations of main portions of the display device shown in FIG. 1

FIG. 3 is a cross-sectional view taken along a line III-III in FIG. 2.

FIG. 4 is a plan view illustrating a modified example of a light source holding device shown in FIG. 2.

FIG. 5 is a plan view illustrating a light source holding device according to a second preferred embodiment of the present invention.

FIG. 6 is a plan view illustrating a light source holding device according to a third preferred embodiment of the present invention.

FIG. 7 is a plan view illustrating a light source holding device according to a fourth preferred embodiment of the present invention.

### DETAILED DESCRIPTION OF PREFERRED EMBODIMENTS

Hereinafter, preferred embodiments of a light source holding device, an illumination device, and a display device according to the present invention will be described with reference to the drawings. In the following description, the case where a preferred embodiment of the present invention is applied to a liquid crystal display device equipped with a direct type illumination device will be exemplified.

### First Preferred Embodiment

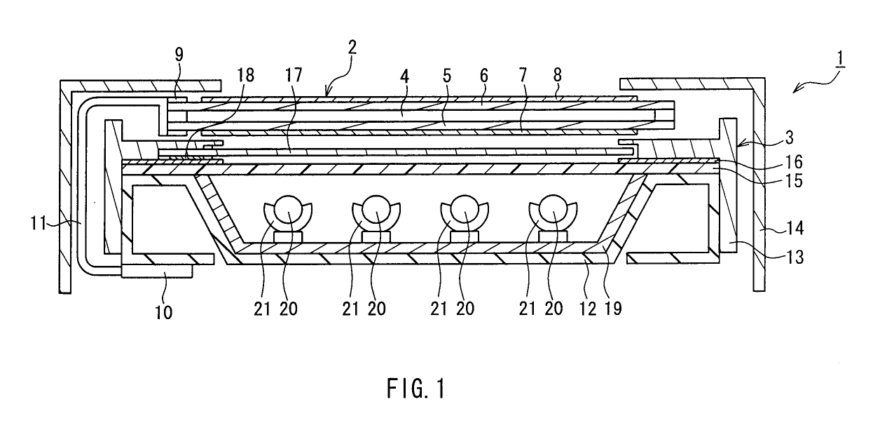

FIG. 1 is a schematic cross-sectional view illustrating a display device according to a first preferred embodiment of the present invention. In FIG. 1, a liquid crystal display device 1 of the present preferred embodiment includes a liquid crystal panel 2 as a display portion that is set with an upper side of the figure being a viewer side (display surface side), and a direct type illumination device 3 that is placed on a non-display surface side (lower side in the figure) of the liquid crystal panel 2 and generates illumination light illuminating the liquid crystal panel 2.

The liquid crystal panel 2 includes a liquid crystal layer 4, a pair of transparent substrates 5, 6 interposing the liquid crystal layer 4 therebetween, and polarizing plates 7, 8 provided respectively on outer surfaces of the transparent substrates 5, 6. Furthermore, the liquid crystal panel 2 is provided with a driver 9 for driving the liquid crystal panel 2, and a driving circuit 10 connected to the driver 9 through a flexible printed board 11, and the liquid crystal panel 2 is configured so as to drive the liquid crystal layer 4 on a pixel basis. Then, in the liquid crystal panel 2, the polarization state of the illumination light incident through the polarizing plate 7 is modulated by the liquid crystal layer 4, and the amount of light passing through the polarizing plate 8 is controlled, whereby a desired image is displayed.

The illumination device 3 is provided with a bottom case 12 whose upper side in the figure (the liquid crystal panel 2 side) is opened, and a frame-shaped frame 13 set on the liquid crystal panel 2 side of the case 12. Furthermore, the case 12 and the frame 13 are preferably made of metal or a synthetic resin, and the case 12 and the frame 13 are interposed by a bezel 14 in an L-shape cross-section while the liquid crystal panel 2 is set above the frame 13, whereby the illumination device 3 is combined with the liquid crystal panel 2 and is integrated therewith as the liquid crystal display device 1.

Furthermore, the illumination device 3 includes a diffusion plate 15 to cover the opening of the case 12, an optical sheet 17 above the diffusion plate 15 on the liquid crystal panel 2 side, and a reflection sheet 19 provided on an inner surface of the case 12. Furthermore, the illumination device 3 is preferably provided with cold cathode tubes 20, for example, as four linear light sources that are held above the reflection sheet 19 in the case 12 by light source holding devices 21 of various preferred embodiments of the present invention at a predetermined interval (pitch) size in the right and left direction in FIG. 1.

The diffusion plate 15 is composed of, for example, a synthetic resin or a glass material preferably having a substantially rectangular shape with a thickness of about 2 mm, for example, and diffuses light (containing light reflected from the reflection sheet 19) from the cold cathode tubes 20 and outputs it to the optical sheet 17 side. Furthermore, four sides of the diffusion plate 15 are mounted on a frame-shaped surface provided on an upper side of the case 12, and is incorporated in the illumination device 3 while being interposed between the frame-shaped surface of the case 12 and an inner surface of the frame 13 via a pressure member 16 that is elastically deformable. Furthermore, the diffusion plate 15 is supported by a transparent support member (not shown) whose substantially central portion is set on the reflection sheet 19, and is prevented from being bent toward an inner side of the case 12.

Furthermore, the diffusion plate 15 is held movably between the case 12 and the pressure member 16. Thus, even when the expansion/contraction (plastic) deformation of the diffusion plate 15 occurs due to the influence of heat caused by the heat generation of the cold cathode tubes 20 and the increase in temperature inside of the case 12, the plastic deformation is absorbed by the elastic deformation of the pressure member 16, whereby the decrease in diffusion of light from the cold cathode tubes 20 is minimized. Furthermore, it is preferred to use the diffusion plate 15 made of a glass material that is more resistant to heat compared with a synthetic resin since the warpage, yellowing, thermal deformation, and the like caused by the influence of heat are unlikely to occur.

The optical sheet 17 preferably includes a condensing sheet and a diffusion sheet composed of, for example, a synthetic resin film with a thickness of about 0.1 mm to about 0.5 mm, and is configured so as to raise the brightness of the illumination light to the liquid crystal panel 2 and enhance the display quality on the display surface of the liquid crystal panel 2. Furthermore, known optical sheet materials such as a prism sheet and a polarization sheet for performing the enhancement of display performance such as the improvement of a viewing angle on the display surface of the liquid crystal panel 2 and the like are laminated appropriately, if required. Then, the optical sheet 17 is configured so as to convert light output from the diffusion plate 15 into plane-shaped light having a predetermined brightness (e.g., about 500 cd/m²) or more and a uniform brightness and output it to the liquid crystal panel 2 side as illumination light.

Furthermore, in the optical sheet 17, for example, at the center on the left end side of FIG. 1 to be the upper side during the actual use of the liquid crystal display device 1, a protrusion protruding to the left side of the figure is provided. In the optical sheet 17, only the protrusion is interposed between the inner surface of the frame 13 and the pressure member 16 via an elastic material 18. The optical sheet 17 is incorporated in the illumination device 3 so as to expand/contract. Thus, in the optical sheet 17, even when expansion/contraction (plastic) deformation occurs due to the influence of heat caused by the heat generation of the cold cathode tubes 20 and the like, free expansion/contraction deformation can be performed mainly in the protrusion, whereby the occurrence of wrinkles, bending, and the like in the optical sheet 17 can be minimized. Consequently, in the liquid crystal display device 1, the degradation in display quality, such as brightness non-uniformity, caused by the bending and the like of the optical sheet 17 can be minimized on the display surface of the liquid crystal panel 2.

The reflection sheet 19 is composed of, for example, a synthetic resin film with a thickness of about 0.1 mm to about 2.0 mm, and functions as a reflection plate that reflects light of the cold cathode tubes 20 toward the diffusion plate 15. Furthermore, the surface of the reflection sheet 19 on the cold cathode tubes 20 side is coated, for example, with a white color, whereby light emitted from the cold cathode tubes 20 is reflected efficiently to the diffusion plate 15 side to enhance the light use efficiency and the brightness in the diffusion plate 15. Alternatively, the reflection sheet 19 may be composed of a thin film made of metal having a high light reflectance such as aluminum or silver.

A straight-tube fluorescent lamp type is used for each cold cathode tube 20, and electrode portions (not shown) provided at both ends thereof are supported on an outer side of the case 12. Furthermore, a thin tube excellent in a light-emission efficiency preferably with a diameter of about 3.0 mm to about 4.0 mm also is used for each cold cathode tube 20.

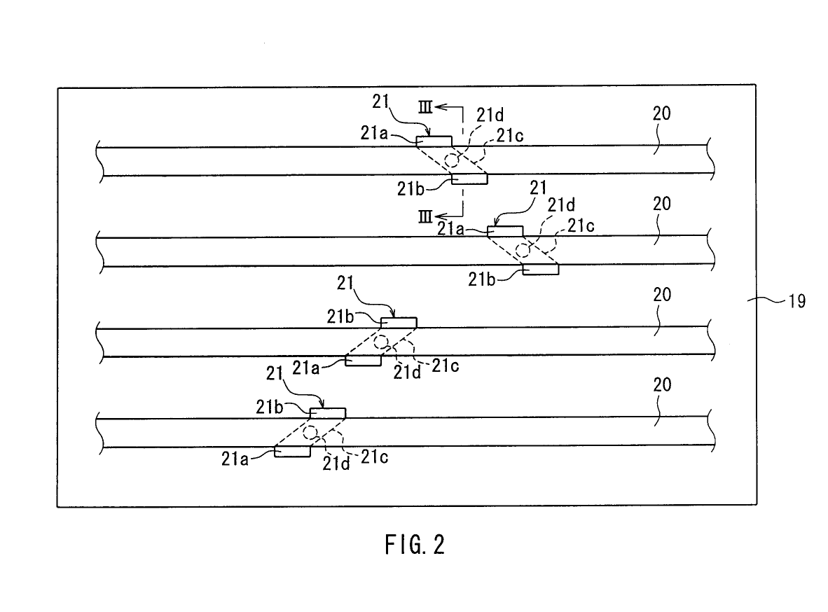

Also referring to FIG. 2, a light source holding device 21 is mounted at a substantially intermediate position in the longitudinal direction (right and left direction of FIG. 2) of each cold cathode tube 20, thereby supporting the cold cathode tube 20. Thus, the cold cathode tube 20 can be supported in an effective light-emitting portion in the case 12 of the cold cathode tube 20 while the occurrence of sagging caused by the weight is minimized. More specifically, the light source holding device 21 enables the cold cathode tube 20 to be placed in the case 12 while the distance between the cold cathode tube 20 and the diffusion plate 15 and the distance between the cold cathode tube 20 and the reflection sheet 19 respectively are kept to predetermined distances.

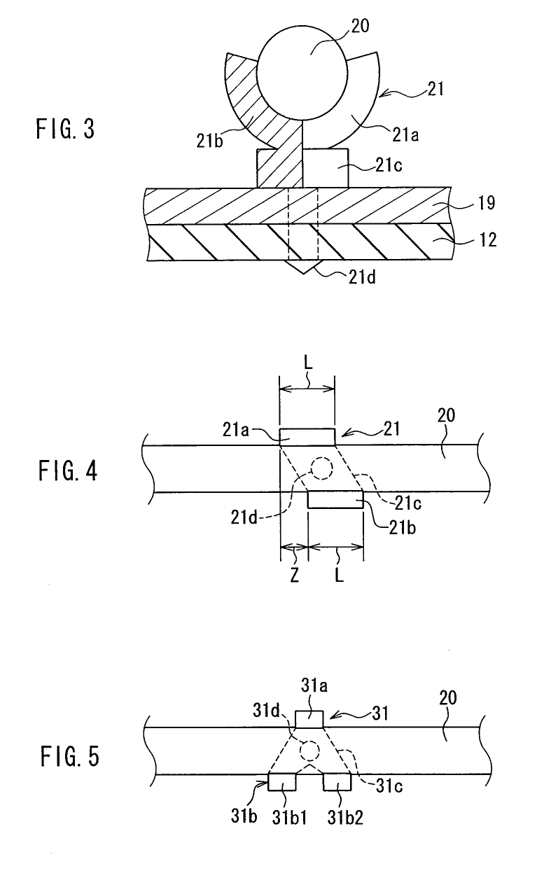

Furthermore, the light source holding device 21 is preferably composed of, for example, a polycarbonate (PC) resin that has a white or milk white color and has flexibility, and the entire light source holding device 21 is formed integrally by injection molding. Also referring to FIG. 3, the light source holding device 21 is provided with first and second claws 21a, 21b whose inner surfaces are formed respectively in an arc shape in cross-section so as to be in contact with the outer surface of the cold cathode tube 20, and the light source holding device 21 holds the cold cathode tube 20 by clamping it between the first and second claws 21a, 21b. Thus, as shown in FIG. 3, by forming the first and second claws 21a, 21b to have an arc shape in cross-section, the light source holding device 21 can hold the cold cathode tube 20 without covering an upper side portion of the cold cathode tube 20 opposed to the dispersion plate 15.

Furthermore, the light source holding device 21 includes a base portion 21c having a plate shaped configuration which is placed below the cold cathode tube 20 and to which each lower end side of the first and second claws 21a, 21b is connected, and a substantially cylindrical engagement portion 21d arranged so as to protrude from the surface of the base portion 21c on an opposite side of the claws 21a, 21b. Then, in the light source holding device 21, the engagement portion 21d is inserted in each attachment hole formed in the reflection sheet 19 and the case 12, and a conical portion provided at a tip end of the engagement portion 21d comes into contact with the outer surface of the case 12, whereby the light source holding device 21 is combined with the illumination device 3. Alternatively, the light source holding device 21 may be combined with the illumination device 3 with a fixing member such as a pin.

Furthermore, the first claw 21a defines one claw provided on either one of an upper side and a lower side of the cold cathode tube 20 in the longitudinal direction of the cold cathode tube 20. On the other hand, the second claw 21b defines the other claw provided on the other of the upper side and the lower side of the cold cathode tube 20. The first and second claws 21a, 21b preferably have the same shape, and the respective contact areas with respect to the cold cathode tube 20 are preferably the same. Thus, in the light source holding device 21, the cold cathode tube 20 can be clamped between the first and second claws 21a, 21b in a balanced state, whereby the cold cathode tube 20 can be kept in a more stable state.

Furthermore, as shown in FIG. 2, the first and second claws 21a, 21b are arranged so as to be in contact with the cold cathode tube 20 while being displaced in position in the longitudinal direction of the cold cathode tube 20. More specifically, the first and second claws 21a, 21b are arranged such that the respective contact positions with respect to the cold cathode tube 20 are different in the longitudinal direction so that a right (left) end of the first claw 21a and a left (right) end of the second claw 21b are matched with each other in a direction substantially perpendicular to the longitudinal direction. Thus, the cold cathode tube 20 is held so that the first and second claws 21a, 21b are not opposed to each other in the direction substantially perpendicular to the longitudinal direction, i.e., portions of the cold cathode tube 20 opposed to the contact portions of the claws 21a, 21b are not covered respectively with the claws 21b, 21a.

Furthermore, as shown in FIG. 2, in the four light source holding devices 21 respectively provided at the four cold cathode tubes 20, the corresponding mounting positions of the four light source holding devices 21 with respect to the cold cathode tubes 20 in the longitudinal direction are different so that they are not placed on a straight line in the direction substantially perpendicular to the longitudinal direction, whereby the shadow of each light source holding device 21 is reduced to a minimum on the display surface.

In the present preferred embodiment configured as described above, the first and second claws 21a, 21b of the light source holding device 21 are arranged so as to be in contact with the cold cathode tube 20 while being displaced in position in the longitudinal direction in such a manner that the first and second claws 21a, 21b are not opposed to each other in the direction substantially perpendicular to the longitudinal direction of the cold cathode tube (linear light source) 20. This can prevent, unlike the above-described conventional example, the surface of the cold cathode tube 20 from being blocked simultaneously by the first and second claws 21a, 21b in the direction substantially perpendicular to the longitudinal direction of the cold cathode tube 20. As a result, the brightness of light output from the cold cathode tube 20 can be minimized from decreasing partially, and the occurrence of a light portion and a dark portion in the longitudinal direction of the cold cathode tube 20 can be minimized. Thus, the illumination device 3 can emit plane-shaped light having a uniform brightness, and the liquid crystal display device 1 can prevent brightness non-uniformity from occurring on the display surface of the liquid crystal panel 2, and prevent shadows of the claws from appearing remarkably, thereby preventing the degradation in display quality of the liquid crystal display device 1.

Furthermore, as described above, the partial decrease in brightness of light from the cold cathode tube 20 caused by the light source holding device 21 can be minimized. Therefore, in the present preferred embodiment, the illumination device 3 and the liquid crystal display device 1, which are thin and excellent in display quality, can be configured at a low cost. More specifically, for example, even in the case where the number of optical sheet materials included in the optical sheet 17 is decreased in order to reduce the cost of the liquid crystal display device 1 and the distance between the dispersion plate 15 and the reflection sheet 19 is decreased in order to reduce the thickness of the liquid crystal display device 1 (illumination device 3), whereby the light source holding device 21 is placed close to the display surface of the liquid crystal panel 2, the difference in relative brightness of light (difference in amount of output light) from the cold cathode tube 20 between the mounting portion of the light source holding device 21 and the other portion is decreased, which can prevent the degradation in display quality, such as brightness non-uniformity.

Furthermore, in the above description, as shown in FIG. 2, the case where the first and second claws 21a, 21b are displaced in contact position so as not to be opposed to each other in the direction substantially perpendicular to the longitudinal direction of the cold cathode tube 20 has been illustrated. However, the light source holding device 21 of the present preferred embodiment only needs to reduce the surface of the cold cathode tube 20 that is blocked simultaneously by two claws in the direction substantially perpendicular to the longitudinal direction. More preferably, the light source holding device 21 only needs to satisfy the following inequality (1) considering a production error and the like of the light source holding device 21. Specifically, in FIG. 4, when the size of the first claw 21a in the longitudinal direction is L, and a displacement size in the longitudinal direction of the second claw 21b with respect to the first claw 21a is Z, these sizes L and Z only need to satisfy the inequality:

0.1×L≦Z. (1):

It should be noted that, it is preferred to set the displacement size Z to be the size L or less, because the holding (grabbing) force of the first and second claws 21a, 21b can be more precise, and the degradation in display quality can be prevented while the cold cathode tube 20 is held precisely in a stable state by the light source holding device 21.

Furthermore, the shape and configuration of the light source holding device 21 such as the displacement size Z also can be changed appropriately, depending upon the diameter and light-emission brightness of the cold cathode tube 20, the distance between the cold cathode tube 20 and the liquid crystal panel 2, the optical characteristics such as the transmittance and haze ratio (hazing degree) of the diffusion pate 15, or the configuration and optical characteristics of the optical sheet 17.

### Second Preferred Embodiment

FIG. 5 is a plan view illustrating a light source holding device of a display device according to the second preferred embodiment of the present invention. In the figure, the difference between the present preferred embodiment and the first preferred embodiment mainly lies in that the second claw is divided into a plurality of claw portions in the longitudinal direction of the cold cathode tube. The components common to those in the first preferred embodiment are denoted with the same reference numerals as those therein, and the repeated description thereof will be omitted.

More specifically, as shown in FIG. 5, a light source holding device 31 of the present preferred embodiment includes a first claw 31a that is in contact with the outer surface of the cold cathode tube 20 on the upper side thereof, and a second claw 31b that is in contact with the outer surface of the cold cathode tube 20 on the lower side thereof, and the second claw 31b includes two claw portions 31b1, 31b2 divided in the longitudinal direction of the cold cathode tube 20. Furthermore, the light source holding device 31 is provided with a plate-shaped base portion 31c which is placed below the cold cathode tube 20 and to which the respective lower end sides of the first claw 31a and the claw portions 31b1, 31b2 are connected, and an engagement portion 31d arranged on the lower side of the base portion 31c and engaged on the case 12 (FIG. 1) side.

The first claw 31a and the respective claw portions 31b1, 31b2 have the same contact area with respect to the cold cathode tube 20, and are preferably have the same shape. Furthermore, the first claw 31a and the claw portions 31b1, 31b2 are arranged so as not to be opposed to each other in the direction substantially perpendicular to the longitudinal direction of the cold cathode tube 20. That is, as shown in FIG. 5, a left end and a right end of the first claw 31a respectively are arranged so as to be matched with a right end of the claw portion 31b1 and a left end of the claw portion 31b2 in the direction substantially perpendicular to the longitudinal direction.

As described above, in the present preferred embodiment, the second claw 31b is divided into the two claw portions 31b1, 31b2 in the direction substantially perpendicular to the longitudinal direction of the cold cathode tube 20, and the claw portions 31b1, 31b2 are arranged so as not to be opposed to the first claw 31a in the longitudinal direction of the cold cathode tube 20. Therefore, in the same way as in the first preferred embodiment, the surface of the cold cathode tube 20 can be prevented from being blocked simultaneously by the first and second claws 31a, 31b, and the degradation in display quality of the liquid crystal display device 1 also can be prevented. Furthermore, the second claw 31b is divided into the two claw portions 31b1, 31b2, so that the surface of the cold cathode tube 20 blocked by the first claw 31a or the second claw 31b in the longitudinal direction of the cold cathode tube 20 can be subdivided to be reduced in size. This enables the difference in relative brightness of light from the cold cathode tube 20 between the mounting portion of the light source holding device 31 and the other portion can be decreased further, and the degradation in display quality, such as brightness non-uniformity, can be prevented exactly, compared with the first preferred embodiment. Furthermore, since the second claw 31b has the claw portions 31b1, 31b2 each having the same shape as that of the first claw 31a, the support stiffness of the light source holding device 31 on the lower side of the cold cathode tube 20, on which the gravity of the liquid crystal display device 1 acts during the actual use thereof is enhanced, whereby the cold cathode tube 20 can be held in a more stable state.

### Third Preferred Embodiment

FIG. 6 is a plan view illustrating a light source holding device according to the third preferred embodiment of the present invention. In the figure, the difference between the present preferred embodiment and the first preferred embodiment mainly lies in that the first and second claws respectively are divided into a plurality of claw portions in the longitudinal direction of the cold cathode tube, and the claw portions of the first and second claws are arranged alternately so as not be opposed to each other in the direction substantially perpendicular to the longitudinal direction of the cold cathode tube. The components common to those in the first preferred embodiment are denoted with the same reference numerals as those therein, and the repeated description thereof will be omitted.

More specifically, as shown in FIG. 6, a light source holding device 41 of the present preferred embodiment is provided with a first claw 41a and a second claw 41b respectively in contact with the outer surface of the cold cathode tube 20 on the upper side and the lower side of the cold cathode tube 20. The first claw 41a includes, for example, three claw portions 41a1, 41a2, and 41a3 divided in the longitudinal direction. Similarly, the second claw 41b includes, for example, three claw portions 41b1, 41b2, and 41b3 divided in the longitudinal direction. Furthermore, the light source holding device 41 is provided with a plate-shaped base portion 41c which is placed below the cold cathode tube 20 and to which the respective lower end sides of the claw portions 41a1 to 41a3 and the claw portions 41b1 to 41b3 are connected, and an engagement portion 41d formed on the lower side of the base portion 41c and engaged on the case 12 (FIG. 1) side.

The claw portions 41a1 to 41a3 and the claw portions 41b1 to 41b3 respectively have the same contact area with respect to the cold cathode tube 20, and have the same shape. Furthermore, in the first claw 41a and the second claw 41b, the claw portions 41a1 to 41a3 and the claw portions 41b1 to 41b3 are arranged so as not to be opposed to each other in the direction substantially perpendicular to the longitudinal direction of the cold cathode tube 20. That is, as shown in FIG. 6, a left end and a right end of the claw portion 41b1 respectively are arranged so as to be matched with a right end of the claw portion 41a1 and a left end of the claw portion 41a2 in the direction substantially perpendicular to the longitudinal direction. A left end and a right end of the claw portion 41b2 respectively are arranged so as to be matched with a right end of the claw portion 41a2 and a left end of the claw portion 41a3 in the direction substantially perpendicular to the longitudinal direction. Then, a left end of the claw portion 41b3 is arranged so as to be matched with a right end of the claw portion 41a3 in the direction substantially perpendicular to the longitudinal direction.

As described above, according to the present preferred embodiment, the first and second claws 41a, 41b respectively are preferably divided into the three claw portions 41a1 to 41a3 and the three claw portions 41b1 to 41b3 in the longitudinal direction of the cold cathode tube 20, and the claw portions 41a1 to 41a3 and the claw portions 41b1 to 41b3 are arranged so as not to be opposed to each other in the direction substantially perpendicular to the longitudinal direction of the cold cathode tube 20. Therefore, in the same way as in the first preferred embodiment, the surface of the cold cathode tube 20 can be prevented from being blocked simultaneously by the first and second claws 41a, 41b, and the degradation in display quality of the liquid crystal display device 1 also can be prevented. Furthermore, the first and second claws 41a, 41b respectively are preferably divided into the three claw portions 41a1 to 41a3 and the claw portions 41b1 to 41b3, so that the surface of the cold cathode tube 20 blocked by the first claw 41a or the second claw 41b can be subdivided to be reduced in size in the longitudinal direction of the cold cathode tube 20, whereby the difference in relative brightness of light from the cold cathode tube 20 between the mounting portion of the light source holding device 41 and the other portion can be decreased, and the degradation in display quality, such as brightness non-uniformity, can be further prevented, compared with the first preferred embodiment.

### Fourth Preferred Embodiment

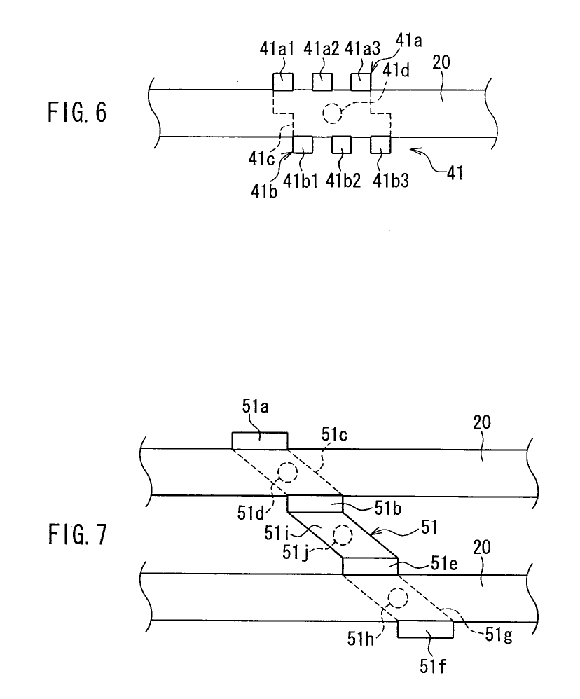

FIG. 7 is a plan view illustrating a light source holding device of a display device according to the fourth preferred embodiment of the present invention. In the figure, the difference between the present preferred embodiment and the first preferred embodiment mainly lies in that a plurality of sets of two claws, respectively holding a plurality of cold cathode tubes, are provided, and two sets of two claws adjacent to each other in the direction substantially perpendicular to the longitudinal direction of the cold cathode tubes are connected with a connecting portion. The components common to those in the first preferred embodiment are denoted with the same reference numerals as those therein, and the repeated description thereof will be omitted.

More specifically, as illustrated in FIG. 7, a light source holding device 51 of the present preferred embodiment is provided with first and second claws 51a, 51b clamping the cold cathode tube 20 therebetween on the upper side of the figure, and first and second claws 51e, 51f clamping the cold cathode tube 20 therebetween on the lower side of the figure. The respective lower end sides of the first and second claws 51a, 51b are connected to a plate-shaped base portion 51c placed below the cold cathode tube 20 on the upper side, the respective lower end sides of the first and second claws 51e, 51f are connected to a plate-shaped base portion 51g placed below the cold cathode tube 20 on the lower side, and the base portions 51c, 51g are connected integrally with a connecting portion 51i placed below the cold cathode tubes 20.

On the respective lower sides of the base portions 51c, 51g and the connecting portion 51i, engagement portions 51d, 51h, and 51j are provided, and are engaged on the case 12 (FIG. 1) side. Alternatively, for example, the engagement portions 51d, 51h are omitted, and only the engagement portion 51j is provided at the light source holding device 51, whereby the light source holding device 51 also can be combined with the illumination device 3 with the engagement portion 51j.

The first claws 51a, 51e and the second claws 51b, 51f respectively are configured so as to have the same contact area with respect to the cold cathode tubes 20 in the same shape. Furthermore, the first claws 51a, 51e, and the second claws 51b, 51f are arranged so as not be opposed to each other in the direction substantially perpendicular to the longitudinal direction of the cold cathode tubes 20. That is, as shown in FIG. 7, a left end and a right end of the second claw 51b respectively are arranged so as to be matched with a right end of the first claw 51a and a left end of the first claw 51e in the direction substantially perpendicular to the longitudinal direction. Furthermore, a right end of the first claw 51e is arranged so as to be matched with a left end of the second claw 51f in the direction perpendicular to the longitudinal direction, and the first claws 51a, 51e and the second claws 51b, 51f preferably have a stepped shape arrangement with the base portions 51c, 51g and the connecting portion 51i. That is, the connecting portion 51i connects the first claws 51a, 51e to the second claws 51b, 51f diagonally to the longitudinal direction so that the first claws 51a, 51e and the second claws 51b, 51f are not arranged on a straight line in the direction substantially perpendicular to the longitudinal direction. Consequently, the appearance of the shadow of the light source holding device 51 is minimized on the display surface of the liquid crystal panel 2 while the brightness of light output from each cold cathode tube 20 is further minimized from being partially decreased.

Due to the above-described configuration, in the present preferred embodiment, the connecting portion 51i connects two sets of the first and second claws 51a, 51e, 51b, 51f respectively holding the two cold cathode tubes 20, so that the light source holding device 51 can hold two upper and lower cold cathode tubes 20 integrally. Furthermore, the light source holding device 51 easily can keep an interval (pitch) size between the two cold cathode tubes 20 to be a desired size, and the degradation in display quality caused by the positional displacement of the cold cathode tubes 20 can be further prevented.

The above-described respective preferred embodiments do not limit the present invention but are shown merely for illustrative purposes. The technical range of the present invention is defined by the scope of the claims, and all the modifications within the range equal to that of the configuration described in the claims also are included in the technical range of the present invention.

For example, in the above description, although the case where a preferred embodiment of the present invention is applied to a liquid crystal display device having a direct type illumination device has been illustrated, the present invention is not limited thereto. The present invention can be applied to various kinds of display devices such as a projection type display device (including a rear projection type) having a non-light-emitting display portion that displays information on images, characters, and the like, using light of the linear light source, or an edge-light type liquid crystal display device with the linear light source set on the side of a liquid crystal panel.

Furthermore, alternatively, the present invention can be used preferably as a film viewer irradiating light to a radiograph, a light box for irradiating light to a picture negative to make it easy to recognize the negative visually, and an illumination device (backlight) of a light-emitting device that lights up a signboard, an advertisement set on a wall surface in a station, or the like.

Furthermore, in the above description, the case where a cold cathode tube is used as a linear light source has been illustrated. However, the light source holding device of the present invention may be a device in which one claw and the other claw of two claws are arranged so as to be in contact with the linear light source while being displaced in position in the longitudinal direction of the linear light source, and a discharge tube such as a hot cathode tube, other fluorescent tubes, or a xenon tube that is a mercury-less lamp may be used as the linear light source.

Furthermore, alternatively, a plurality of light-emitting diodes (LEDs) also can be used, which are designed as linear light sources by being composed of a material having excellent light transparency such as a glass tube and being embedded while being arranged on a straight line in a tubular member held by the light source holding device of the preferred embodiments of the present invention. Even in the case where such LEDs are used, in the same way as in the case of using the linear light sources, the light source holding device can keep the LEDs in a stable state while minimizing the partial decrease in brightness of light, whereby an illumination device capable of emitting plane-shaped light that is uniform with a high brightness can be easily configured.

Furthermore, in the above description, the case where the light source holding device is applied to the cold cathode tube that is configured in the straight line (straight tube) shape as a whole has been illustrated. However, the light source holding device of the present invention also can be applied even to a non-straight tube lamp that has a substantially U-shaped configuration.

Furthermore, in the above description, although the case where one light source holding device is mounted at a substantially intermediate position of the linear light source has been illustrated, the present invention is not limited thereto. For example, in the case where the length of the linear light source is extended in accordance with the enlargement of a screen of a liquid crystal display device, the linear light source also can be supported at a plurality of positions by increasing the number of light source holding devices appropriately.

In the above description, although the case where the entire light source holding device is molded integrally with the white or milk white resin material, the light source holding device of the present invention is not limited thereto, and each portion of the light source holding device such as the claw and base portion is configured as a separate body, or the light source holding device also can be composed of metal such as aluminum, for example. It is preferred that at least the claws of the light source holding device are a white or milk white color, because the claws of substantially the same color as the light-emission color of the linear light source can be configured, and the shadows of the claws are prevented from appearing on the display surface, whereby the degradation in display quality can be prevented more easily. Furthermore, it is preferred that the entire light source holding device is formed integrally, because the influence of thermal expansion in each portion of the light source holding device caused by heat generated from the linear light source is minimized, and the linear light source can be held in a more stable state, and further because a light source holding device can be configured easily at a low cost without requiring the operation of combining each portion.

Alternatively, for example, only the first and second claws may be composed of a transparent material, and the base portion may be formed of a white material, preferably a white material having a reflectance substantially equal to that of the reflection sheet. In the case of such a configuration, the brightness of light from the linear light source is minimized from being decreased by the claws, and simultaneously, the light can be reflected to the liquid crystal panel side at the base portion, which can enhance the light use efficiency of the linear light source.

Furthermore, in the above description, as shown in FIG. 3, although the case where the entire inner surface of each of the first and second claws is in contact with the outer surface of the linear light source has been illustrated, the present invention is not limited thereto, and only a portion of the inner surface of each claw may be in contact with the outer surface of the linear light source.

Furthermore, in the above description, although the configuration using a reflection sheet for the reflection plate has been illustrated, the reflection plate of the present invention is not limited thereto. For example, a reflection surface provided on an inner surface of a housing of an illumination device or a display device, or the inner surface of the housing coated with a coating having a high light reflectance may be used for the reflection plate.

Furthermore, in each of the second to fourth preferred embodiments, although the configuration in which the first and second claws (including the claw portions divided in the longitudinal direction) are arranged so as not to be opposed to each other in the direction substantially perpendicular to the longitudinal direction of the linear light source has been illustrated, portions of two claws may be opposed to each other as shown in FIG. 4.

The light source holding device according to the preferred embodiments of the present invention, and the illumination device and the display device that use the light source holding device can minimize the brightness of light output from a linear light source from being decreased partially, so that a light source holding device capable of preventing the degradation in display quality to enhance display performance, and an illumination device and a display device using the light source holding device can be provided.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-15. (canceled)

16. A light source holding device for holding a linear light source comprising:
two claws arranged to clamp the linear light source between the two claws; wherein
the two claws are arranged so as to be in contact with the linear light source while being displaced in position with respect to each other in a longitudinal direction of the linear light source.

17. The light source holding device according to claim 16, further comprising a base portion which is arranged below the linear light source and to which a lower end side of the two claws is connected, wherein the base portion is provided with an engagement portion that is engaged with a reflection plate reflecting light from the linear light source.

18. The light source holding device according to claim 16, wherein assuming that a size of the one of the two claws in the longitudinal direction of the linear light source is L and a displacement size of the other of the two claws with respect to the one claw in the longitudinal direction of the linear light source is Z, the size L and the displacement size Z satisfy the following inequality:
0.1×L≦Z.

19. The light source holding device according to claim 18, wherein the displacement size Z is a value equal to or lower than the size L.

20. The light source holding device according to claim 16, wherein at least one of the two claws is divided into a plurality of claw portions in the longitudinal direction of the linear light source.

21. The light source holding device according to claim 16, wherein the two claws respectively are divided into a plurality of claw portions in the longitudinal direction of the linear light source, and the claw portions of the two claws are arranged alternately so as not to be opposed to each other in a direction substantially perpendicular to the longitudinal direction of the linear light source.

22. The light source holding device according to claim 16, wherein a contact area between one of the two claws and the linear light source is equal to a contact area between the other of the two claws and the linear light source.

23. The light source holding device according to claim 16, further comprising a plurality of sets of the two claws respectively arranged to hold a plurality of linear light sources, and a connecting portion connecting two sets of the two claws adjacent to each other in the direction substantially perpendicular to the longitudinal direction of the linear light source.

24. The light source holding device according to claim 23, wherein the connecting portion connects the two sets of the two claws diagonally with respect to the longitudinal direction so that the two sets of the two claws are not located on a straight line in the direction substantially perpendicular to the longitudinal direction of the linear light source.

25. The light source holding device according to claim 16, wherein the entire light source holding device is defined by a single integral unitary body made of a metal or resin material.

26. The light source holding device according to claim 16, wherein the claws have a white or milk white color.

27. An illumination device comprising:
a linear light source; and
the light source holding device according to claim 16 arranged to hold the linear light source.

28. The illumination device according to claim 27, wherein the linear light source comprises a discharge tube defined by one of a cold cathode tube, a hot cathode tube, a xenon tube, or a plurality of light-emitting diodes arranged along a straight line.

29. A display device comprising:
a linear light source and a display portion irradiated with light from the linear light source; and
the light source holding device according to claim 16 arranged to hold the linear light source.

30. The display device according to claim 29, wherein the display portion is a liquid crystal panel.
